(19) United States
(12) Patent Application Publication
(10) Pub. No.: US 2026/0228534 A1
(43) Pub. Date: Aug. 6, 2026

(54) METHOD AND APPARATUS FOR FAST ADAPTIVE NEURAL NETWORK TRAINING

(71) Applicants: CYNTHIA KATHERINE NGUYEN, MILPITAS, CA (US); DARRION VINH NGUYEN, MILPITAS, CA (US); ANTHONY JUSTIN NGUYEN, MILPITAS, CA (US)

(72) Inventors: CYNTHIA KATHERINE NGUYEN, MILPITAS, CA (US); DARRION VINH NGUYEN, MILPITAS, CA (US); ANTHONY JUSTIN NGUYEN, MILPITAS, CA (US)

(21) Appl. No.: 19/042,036

(22) Filed: Jan. 31, 2025

(51) Int. Cl. G06N 3/084; G06N 3/0985

(52) U.S. Cl. CPC G06N 3/084; G06N 3/0985

(57) ABSTRACT

A method and apparatus for training neural networks and other machine learning models using higher-order derivative approximation. The method uses two or more gradients in a parameter update path to calculate an approximation of the directional derivative of the gradient in the opposite direction of the gradient. This approximation is then used to compute per-parameter adaptive learning rates for updating model parameters. The method can provide fast convergence for many artificial intelligence training applications while maintaining computational and memory efficiency comparable to those of known first-order methods.

### TECHNICAL FIELD

The present disclosure relates generally to the training of machine learning models, particularly artificial neural networks such as Convolutional Neural Networks (CNNs) and Large Language Models (LLMs), utilizing adaptive learning rates.

### BACKGROUND

In recent years, the field of artificial intelligence (AI) has experienced remarkable advancements, with deep learning techniques becoming the cornerstone of many modern applications. Artificial neural networks, in particular, have demonstrated exceptional capabilities across diverse domains, including computer vision, natural language processing, and robotics. However, training these neural networks remains a computationally intensive process, often requiring significant hardware resources and energy consumption.

Optimizers play a central role in the training process by adjusting the neural network's parameters to minimize a loss function that represents the network's errors. One of the most commonly used optimization methods is Stochastic Gradient Descent (SGD). SGD updates parameters using the gradient of the loss function with respect to the parameters, computed from a batch of data samples at each iteration. While SGD is appreciated for its simplicity and scalability, it often requires challenging hyperparameter tuning and may converge only slowly.

Another widely adopted optimizer is Adam (Adaptive Moment Estimation), which has become a leading choice for training large language models (LLMs) due to its ability to combine adaptive learning rates with momentum-based updates. The Adam method leverages moving averages of the gradients (first-order moments) and the squared gradients (second-order moments) to adaptively scale the learning rate for each parameter. Despite its effectiveness, Adam and similar adaptive methods demand extensive computational resources.

Second-order optimization methods, such as Newton's method and its variants, have also been explored for neural network training. These methods utilize curvature information from the second-order Hessian matrix or its approximations to achieve faster convergence. However, their practical application is limited, as computing and storing the Hessian matrix or its approximations is computationally expensive, particularly in high-dimensional parameter spaces. To address these challenges, Hessian-free optimization methods have been developed. These methods avoid explicitly computing the Hessian matrix, instead approximating its effects using conjugate gradient vectors. While Hessian-free methods reduce memory and computational demands, they remain resource-intensive and are often outperformed by Adam and other adaptive optimization algorithms in training neural networks.

Given these challenges, there is a pressing and growing need for more efficient neural network training systems that can achieve faster convergence while reducing computational and energy demands.

### SUMMARY

In one aspect, a computer-implemented method to train a neural network or machine learning model is provided. A parameter vector of the model is calculated in each training iteration to minimize the model's loss function. The method utilizes two or more gradients of the loss function at two or more parameter vectors from the current and previous training iterations to calculate a derivative of gradient in its opposite direction (DGOD) vector which approximates the directional derivative of the gradient at the current parameter vector in the opposite direction of the gradient. The DGOD vector is then used to calculate a per-parameter adaptive learning rate vector, wherein the adaptive learning rate of a parameter is inversely proportional to the element of the DGOD vector associated with that parameter, except when the element of the DGOD vector associated with the parameter is smaller than a predetermined threshold, in which case a bounded adaptive learning rate is applied. The adaptive learning rate vector and either the gradient at the current parameter vector or a gradient moving average are then used to calculate an update to the current parameter vector of the network.

The above and other aspects of the present invention will become more apparent from the detailed description herein together with the accompanying drawings.

### BRIEF DESCRIPTION OF THE DRAWINGS

To provide a more complete understanding of the present disclosure and its advantages, reference is made to the attached drawings.

FIG. 1 illustrates the calculation of a Derivative of the Gradient in its Opposite Direction (DGOD) vector using two gradients along an update path.

FIG. 2 illustrates the calculation of a Derivative of the Gradient in its Opposite Direction (DGOD) vector using three or more gradients along an update path.

FIG. 3 is a flowchart of an embodiment of a method for training a machine learning model using DGOD vectors calculated from two gradients.

FIG. 4 is a flowchart of an embodiment of a method for training a neural network using average DGOD vectors calculated from two gradient moving averages.

FIG. 5 is a graph comparing the convergence of the present method as embodied in FIG. 4 with that of the Adam method when training a multi-layer fully connected neural network.

FIG. 6 is a graph comparing the convergence of the present method as embodied in FIG. 3 with those of the Stochastic Gradient Descent and Adam methods when optimizing a deterministic machine learning model with a cubic polynomial loss function.

FIG. 7 is a chart comparing the update path of the present method as embodied in FIG. 3 with the update paths of the Stochastic Gradient Descent and Adam methods when optimizing a deterministic machine learning model with the same cubic polynomial loss function applicable in FIG. 6.

FIG. 8 is a schematic diagram of an exemplary computer-enabled neural network training system for implementing embodiments of the present method.

### DETAILED DESCRIPTION

Embodiments of the present method and apparatus for training artificial neural networks and other machine learning models will now be described with reference to the figures. To provide a comprehensive understanding of the described embodiments, numerous specific details are included. However, those skilled in the art will recognize that the embodiments can be implemented without necessarily relying on these specific details. In some instances, commonly known methods, processes, and components are not elaborated upon to avoid overshadowing the described embodiments. Furthermore, this description should not be interpreted as limiting the scope of the disclosed embodiments.

In the context of training a neural network or machine learning model, the following terms, as used in this specification, are defined below. These definitions clarify the terminology employed and are not intended to restrict the scope of the claims unless explicitly stated otherwise:

Parameter Vector: Refers to the numerical configurations that define the behavior of a machine learning model. For a neural network model, in particular, the parameter vector typically comprises the connection weights and neuron biases. A parameter vector may be represented as a vector or, alternatively, as a matrix or higher-dimensional tensor depending on the structure of the network. During the training process of a machine learning model, a parameter vector is calculated in each training iteration to minimize the model's loss function.

Current Parameter Vector: The parameter vector in a current iteration of training of a machine learning model.

Update Path: Refers to the series of parameter vectors calculated in the current and past iterations of the training process. The update path reflects the trajectory of parameter updates as the training process progresses. The update path may also be referred to herein as the parameter update path.

Update Direction: The direction in which the parameter vector is updated during an iteration of the training process. The update direction incorporates factors such as gradients and learning rates.

Gradient: The partial derivative of the loss function of a model with respect to the model's parameter vector. In multi-layer neural network models, gradients are typically computed using backpropagation. In this disclosure, “gradient” may also refer to an approximation of the true gradient, often computed from a subset of training data (e.g., a mini-batch) to reduce computational cost.

Training a neural network typically involves using training data to iteratively adjust the network's parameters to optimize its outputs. In a typical training iteration, a batch of input data is passed through the network, where weighted sums, biases, and activation functions produce outputs. The difference between the network's outputs and the expected outputs from the training data is measured using a loss function, which quantifies the network's error. This error is propagated backward through the network using backpropagation to compute the gradient of the loss function with respect to the network's parameters.

A commonly used optimization method, Stochastic Gradient Descent (SGD), updates the parameters by taking small steps in the direction opposite to the gradient, using a single learning rate across all parameters to scale the gradient vector. This process is repeated over multiple iterations, enabling the network to improve its outputs over time. Instead of using a single learning rate, more advanced optimization methods incorporate additional information about the loss function to calculate per-parameter adaptive learning rates, which can result in faster and/or more stable training. For example, the RMSProp and Adam methods use a moving average of the squared gradient (second moment) to calculate adaptive learning rates for individual parameters.

This disclosure presents a new approach for training neural networks and other machine learning models. The present method uses approximations of the directional derivative of the gradient of the loss function in the opposite direction of the gradient to calculate per-parameter adaptive learning rates, which are then used to update the model's parameters.

Formally, the directional derivative of gradient g with respect to parameter vector p in the opposite direction of the gradient is defined as:

$${δ}_{- g} g ( p ) = {lim}_{r \to 0} \frac{g ( p - r . g ) - g ( p )}{r . ‖ g ‖}$$

where r is a scalar, and ∥g∥ is the length (norm) of gradient vector g. Since δ_{-g}g(p) is a derivative of the gradient vector, it is a second-order derivative of the loss function. Note that p, g, and δ_{-g}g(p) are vectors of the same dimension.

In each training iteration, the present method uses two or more gradients at two or more parameter vectors in the parameter update path to calculate a Derivative of Gradient in its Opposite Direction (DGOD) vector which approximates the directional derivative of the gradient of the loss function at the current parameter vector in the opposite direction of the gradient. Each element in the DGOD vector approximates the directional derivative of the partial derivative of the loss function with respect to a parameter in the opposite direction of the gradient. Since the opposite direction of the gradient is the steepest descent direction of the loss function, the DGOD vector approximates the rates of changes of the elements of the gradient vector in the steepest descent direction. The dimension of the DGOD vector is the number of the model's parameters. The present method uses a DGOD vector calculated in each iteration to determine a per-parameter adaptive learning rate vector for that iteration. In particular, the adaptive learning rate for a parameter is inversely proportional to the element of the DGOD vector associated with that parameter; except when the element of the DGOD vector associated with that parameter is negative or near zero, in which case the adaptive learning rate for that parameter is set to a predetermined upper bounded learning rate. The adaptive learning rate vector is then used in conjunction with either the gradient of the loss function at the current parameter vector or a gradient moving average to calculate an update to the current parameter vector. In some embodiments, a moving average of multiple DGOD vectors is used in lieu of a single DGOD vector to calculate the adaptive learning rate vector.

Different methods can be used to calculate a DGOD vector that approximates the directional derivative of the gradient of the loss function in the opposite direction of the gradient. Since the update direction is roughly in the opposite direction of the gradient, two or more gradients at two or more parameter vectors in a recent update path can be used to calculate a DGOD vector that measures the rates of changes of the gradients along the update path as an approximation of the derivative of the gradient in the opposite direction of the gradient.

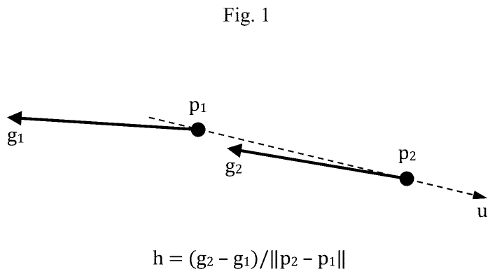

FIG. 1 illustrates the calculation of a DGOD vector using two gradients at two parameter vectors in an update path. Vector g₁ is the gradient or an estimated gradient at parameter vector p₁, and vector g₂ is the gradient or an estimated gradient at parameter vector p₂, wherein p₂ is the update of p₁ in the update path. Since the update direction u=p₂−p₁ is roughly in the opposite direction of the gradient, the directional derivative of the gradient in the opposite direction of the gradient can be roughly approximated by a DGOD vector h, as follows:

$$h = ( {g}_{2} - {g}_{1} ) / ‖ {p}_{2} - {p}_{1} ‖$$

where ∥p₂−p₁∥ is the norm of (p₂−p₁), i.e., the distance from p₁ to p₂.

In some embodiments, p₁ is the model's parameter vector in the current iteration, and p₂ is a parameter vector obtained by making a small exploratory update to p₁ in the opposite direction of the gradient:

$${p}_{2} = {p}_{1} - r . {g}_{1}$$

where r is a small scalar step size such as 0.001. In some embodiments, p₁ is the model's parameter vector pₜ₋₁ in the previous iteration t−1, and p₂ is the model's parameter vector pₜ in the current iteration t. A DGOD vector h can be obtained by calculating:

$$h = ( {g}_{t} - {g}_{t - 1} ) / ‖ {p}_{t} - {p}_{t - 1} ‖$$

where gₜ and gₜ₋₁ are the gradients at pₜ and pₜ₋₁, respectively. Since the direction from pₜ₋₁ to pₜ is the direction of the last parameter update, which is roughly in the opposite direction of the gradient, vector h approximates the directional derivative of the gradient in the opposite direction of the gradient.

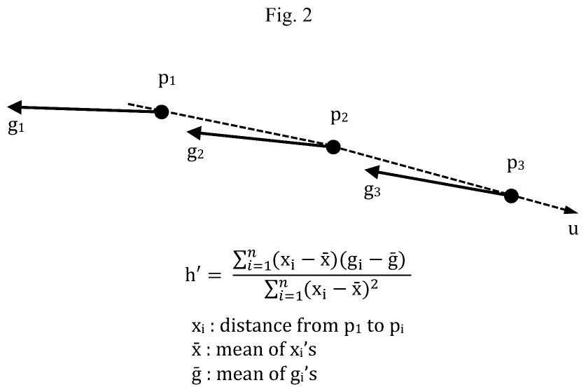

FIG. 2 illustrates the calculation of a DGOD vector using three or more gradients along an update path. Let g₁, g₂, . . . gₙ be gradients or gradient estimates at parameter vectors p₁, p₂, . . . pₙ which are in the update path u of the recent training iterations. DGOD vector h′ can be obtained by calculating the slopes of the linear regression of gradients g₁, g₂, . . . gₙ with respect to the distances from the first parameter vector p₁ to parameter vectors p₁, p₂, . . . pₙ along the update path, as follows:

$${h}^{′} = \frac{{\sum }_{i = 1}^{n} ( {x}_{i} - \overline{x} ) ( {g}_{i} - \overline{g} )}{{\sum }_{i = 1}^{n} {( {x}_{i} - \overline{x} )}^{2}}$$

where x; is the distance from p₁ to pᵢ along the update path u, x̅ is the mean of xᵢ, and g̅ is the mean of g₁:

$$\overline{x} = \frac{{\sum }_{i = 1}^{n} {x}_{i}}{n}$$

$$\overline{g} = \frac{{\sum }_{i = 1}^{n} {g}_{i}}{n}$$

DGOD vector h′ represents the rates of changes of the gradients along the update path. Since the update path of the recent iterations is roughly in the opposite direction of the current gradient, h′ approximates the directional derivative of the gradient in the opposite gradient direction.

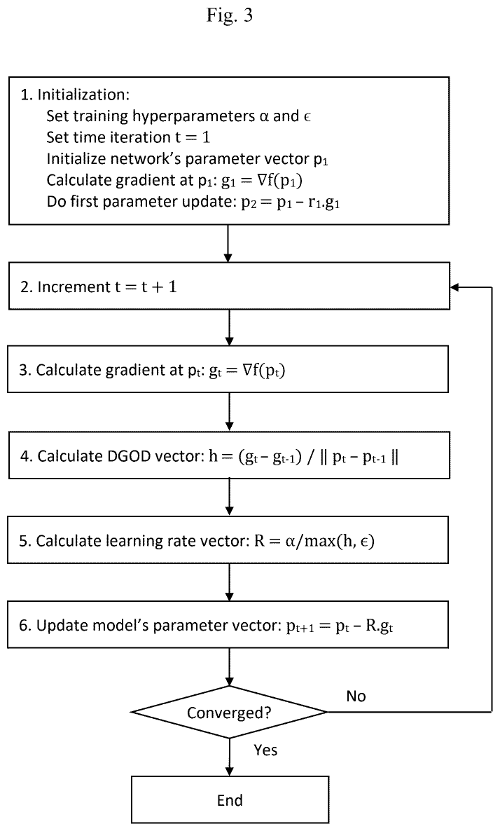

FIG. 3 is a flowchart of an embodiment of the present method to train a machine learning model using DGOD vectors calculated from pairs of gradients. All vector operations in FIG. 3 and in the rest of this disclosure are elementwise. Step 1 is the initial iteration in which training hyperparameters and other variables are initialized. Hyperparameter α is a scalar number between 0 and 1, and threshold ϵ is a small positive number such as 0.1. In the initial iteration, time iteration t is set to 1, the model's parameter vector is initialized to vector p₁, and gradient g₁ of the loss function f at p₁ is calculated using training data: g₁=∇f(p₁). An initial parameter update is then applied to parameter vector p₁ in the steepest descent direction (the opposite direction of g₁) to calculate parameter vector p₂ for the next iteration, as follows:

$${p}_{2} = {p}_{1} - {r}_{1} \cdot {g}_{1}$$

where r₁ is a predetermined initial scalar step size.

Steps 2 to 6 are then carried out to update the model's parameters.

In step 2, time iteration t is incremented by one.

In step 3, training data are used to calculate gradient gr of the loss function f at pₜ, where pₜ is the current parameter vector of the model in the current time iteration t.

In step 4, DGOD vector h is calculated by dividing the difference between gradient gₜ in the current iteration t and gradient gₜ₋₁ in the previous iteration t−1 by the distance from parameter vector pₜ₋₁ in the previous iteration t−1 to parameter vector pₜ in the current iteration t, as follows:

$$h = ( {g}_{t} - {g}_{t - 1} ) / ‖ {p}_{t} - {p}_{t - 1} ‖$$

Since pₜ−pₜ₋₁ is the last parameter update which is roughly in the opposite direction of the current gradient, h approximates the directional derivative of the gradient in the opposite direction of the gradient.

In step 5, DGOD vector h is used to calculate per-parameter adaptive learning rate vector R. Specifically, the adaptive learning rate of a parameter is scalar α divided by the element of the DGOD vector associated with that parameter; except when the element of the DGOD vector associated with that parameter is negative or less than threshold ϵ, in which case the adaptive learning rate of that parameter is α/ϵ:

$$R = α / max ( h , ∈ )$$

Consequently, ratio Rₘₐₓ=α/ϵ is an upper bound of the per-parameter adaptive learning rates. In some embodiments, the upper bound Rₘₐₓ of the adaptive learning rates is a configurable training hyperparameter, and ϵ is derived from Rₘₐₓ as follows:

$$∈ = α / {R}_{max}$$

In step 6, adaptive learning rate vector R is used to scale gradient g to update the model's parameter vector, as follows:

$${p}_{t + 1} = {p}_{t} - R \cdot {g}_{t}$$

Steps 2 to 6 are then repeated until the model's parameters converge, or a predetermined stopping criterion is met.

In some embodiments, steps 4, 5, and 6 are combined. For example, steps 4, 5, and 6 can be executed in one composite calculation:

$${p}_{t + 1} = {p}_{t} - {g}_{t} \cdot α / max ( ( {g}_{t} - {g}_{t - 1} ) / ‖ {p}_{t} - {p}_{t - 1} ‖ , α / {R}_{max} )$$

When the gradients are noisy, e.g., in stochastic training, an average DGOD vector can be used to calculate the adaptive learning rate vector to reduce noises. In some embodiments, an average DGOD vector is obtained by calculating a moving average of multiple DGOD vectors, each of which is calculated by using two or more gradients at two or more parameter vectors in a parameter update path. In some embodiments, an average DGOD vector is calculated from two gradient moving averages from the current and previous iterations.

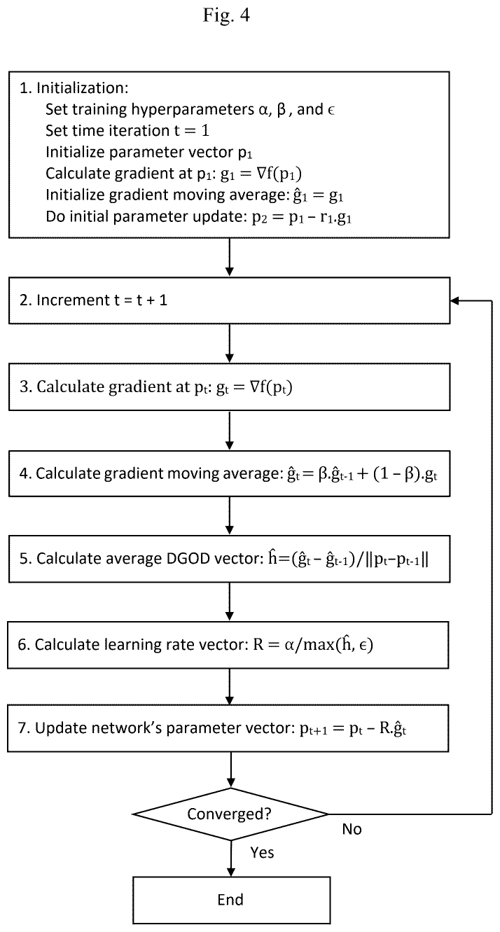

FIG. 4 is a flowchart of an embodiment of a method to train a neural network using average DGOD vectors calculated from gradient moving averages. Step 1 in FIG. 4 is the initial iteration in which training hyperparameters and other variables are initialized. Hyperparameter α is a scalar number between 0 and 1, Bis the exponential decay rate of the gradient moving average, and threshold ϵ is a small positive number such as 0.1. In the initial iteration, time iteration tis set to 1, the network's parameter vector is initialized to p₁, gradient g₁ of the loss function f at p₁ is calculated from training data: g₁=∇f(p₁), and the gradient moving average ĝ₁ is initialized to gradient g₁. An initial parameter update is then applied to parameter vector p₁ in the steepest descent direction (the opposite direction of g₁) to calculate parameter vector p₂ for the next iteration, as follows:

$${p}_{2} = {p}_{1} - {r}_{1} \cdot {g}_{1}$$

where r₁ is a predetermined initial scalar step size.

Steps 2 to 7 are then carried out to update the network's parameters.

In step 2, time iteration t is incremented by 1.

In step 3, a batch of training data is used to calculate estimated gradient gₜ of the loss function f at pₜ, where pₜ is the current parameter vector of the network in the current time iteration t.

In step 4, gradient gₜ is used to calculate gradient moving average § t which is an exponential moving average of the gradients, as follows:

$${\hat{g}}_{t} = β \cdot {\hat{g}}_{t - 1} + ( 1 - β ) \cdot {g}_{t}$$

In step 5, an average DGOD vector h is calculated by dividing the difference between gradient moving average gₜ in the current iteration t and gradient moving average ĝₜ₋₁ in the previous iteration t−1 by the distance from parameter vector pₜ₋₁ in the previous iteration t−1 to parameter vector pₜ in the current iteration t:

$$\hat{h} = ( {\hat{g}}_{t} - {\hat{g}}_{t - 1} ) / ‖ {p}_{t} - {p}_{t - 1} ‖$$

In step 6, average DGOD vector h is used to calculate per-parameter adaptive learning rate vector R. Specifically, the adaptive learning rate of a parameter is scalar α divided by the element of the average DGOD vector associated with that parameter; except when the element of the average DGOD vector associated with that parameter is negative or smaller than threshold ϵ, in which case the adaptive learning rate of that parameter is set to α/ϵ:

$$R = α / max ( \hat{h} , ∈ )$$

Consequently, ratio Rₘₐₓ=α/ϵ is an upper bound of the per-parameter adaptive learning rates. When the element of the average DGOD vector associated with a parameter is smaller than threshold ϵ, the adaptive learning rate of that parameter is the upper bound Rₘₐₓ. In some embodiments, the upper bound Rₘₐₓ is a configurable training hyperparameter, and ϵ is derived from Rₘₐₓ as follows:

$$∈ = α / {R}_{max}$$

In step 7, adaptive learning rate vector R is used to scale gradient moving average ĝₜ to update the network's parameter vector, as follows:

$${p}_{t + 1} = {p}_{t} - R \cdot {\hat{g}}_{t}$$

Steps 2 to 7 are then repeated until the network's parameters converge, or a predetermined stopping criterion is met.

In some embodiments, steps 5, 6 and 7 are combined to avoid calculating the DGOD vector and/or the adaptive learning rate vector explicitly. For example, steps 5, 6, and 7 can be executed implicitly in one composite calculation:

$${p}_{t + 1} = {p}_{t} - {\hat{g}}_{t} \cdot α / max ( ( {\hat{g}}_{t} - {\hat{g}}_{t - 1} ) / ‖ {p}_{t} - {p}_{t - 1} ‖ , α / {R}_{max} )$$

In some embodiments, scalar α and/or upper bound Rₘₐₓ are adaptively adjusted during training. In some embodiments, α and/or Rₘₐₓ are adjusted according to the trend of recent training loss. In particular, α and/or Rₘₐₓ are decreased if the training loss is trending up, which may indicate overshooting; and α and/or Rₘₐₓ are increased if the training loss decreases too slowly. In some embodiments, α and/or Rₘₐₓ are inversely proportional to the variation of DGOD vectors in recent iterations. This controls the training to take smaller, more cautious steps when there are big changes in DGOD vectors, which may indicate that previous iterations have taken steps that are too long.

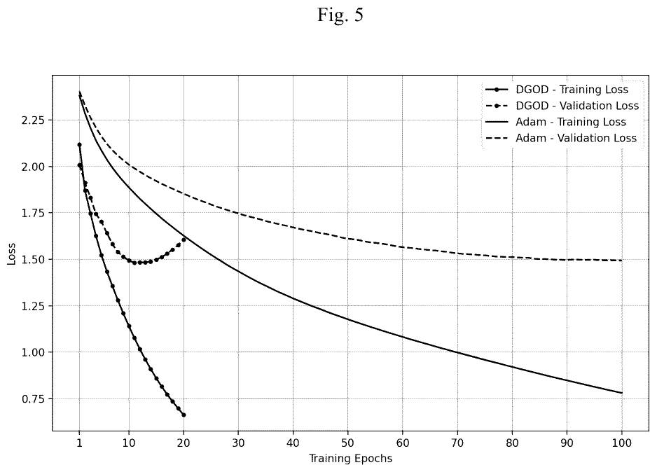

FIG. 5 shows the result of a test that compares the convergence rates of the present DGOD method and the Adam method when training a multi-layer fully connected neural network. In the test, DGOD vectors are calculated from gradient moving averages as described above in relation to FIG. 4. The result shows that the present method converges significantly faster than the Adam method in the test in terms of both training loss and validation loss.

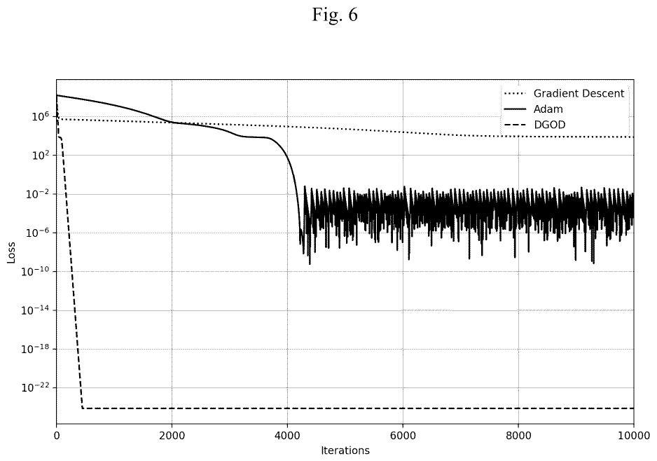

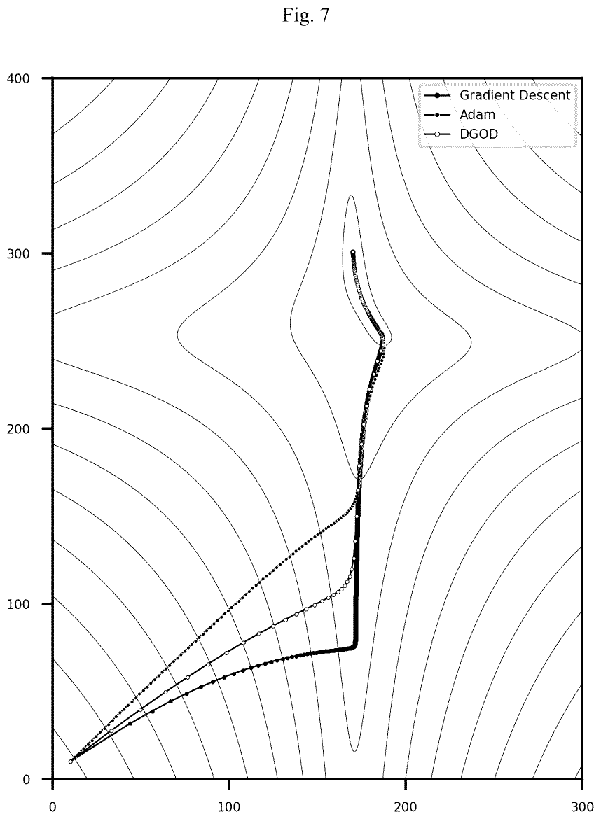

In addition to training neural networks, the present method can also be used to optimize other machine learning models. FIG. 6 shows the result of a test that compares the convergence rates of the present DGOD method as described above in relation to FIG. 3 versus the Stochastic Gradient Descent and Adam methods when optimizing a deterministic machine learning model with a cubic polynomial loss function. The result shows that the present method converges much faster than both the Gradient Descent and Adam methods in the test. FIG. 7 compares the update paths of the Gradient Descent, Adam and present DGOD method as described above in relation to FIG. 3 when optimizing the deterministic machine learning model with the same cubic polynomial loss function as for FIG. 6. The present method has highly adaptive step sizes and reaches the minima in fewer steps than the other methods. The present method decelerates and takes shorter steps when there is a curve in the update path, and it accelerates with longer steps when the path becomes straighter.

The present method is efficient in terms of computational cost. Although it is a second-order method, its computational cost is comparable to that of first-order methods. Calculating a DGOD vector and its associated adaptive learning rate vector requires only a small number of vector operations and does not involve large matrices, unlike other second-order methods such as Newton's method and its variants.

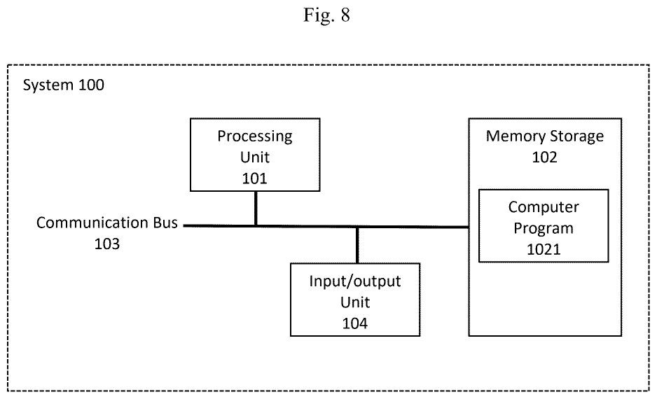

FIG. 8 is a schematic diagram of an exemplary computer-enabled system for implementing embodiments of the present method. A neural network training system (apparatus) 100 comprises at least one processing unit 101 (only one shown), a memory storage 102, a communication bus 103, and an input/output unit 104. The memory storage 102 stores the parameters of the neural network being trained, as well as a computer program 1021 containing instructions to execute a given embodiment of the present method. The processing unit 101 is configured to load the instructions of the computer program 1021 from the memory storage 102 via the communication bus 103. Subsequently, the processing unit 101 loads training data from the input/output unit 104 and executes the instructions of the computer program 1021 to update the neural network's parameters in accordance with a given embodiment of the present method, thereby training the neural network.

The foregoing embodiments are intended to illustrate examples of the present method and apparatus for training neural networks and machine learning models, without limiting their scope. Although the embodiments are described in detail, persons of ordinary skill in the art may make modifications to the described embodiments or implement equivalent replacements for certain technical features without departing from the spirit or scope of the present method and apparatus.

What is claimed is:

1. A computer-implemented method to train a neural network by iteratively updating parameters of the network to minimize a loss function, the method comprising:
obtaining two or more gradients of the loss function at two or more parameter vectors wherein the two or more parameter vectors are in a parameter update path;
using the two or more gradients and a distance(s) between the two or more parameter vectors to calculate a derivative of gradient in its opposite direction (DGOD) vector which approximates a directional derivative of a gradient at a current parameter vector of the network in the opposite direction of the gradient at the current parameter vector of the network;
using the DGOD vector to calculate a per-parameter adaptive learning rate vector, wherein an adaptive learning rate of a parameter of the network is inversely proportional to an element of the DGOD vector associated with the parameter, except when the element of the DGOD vector associated with the parameter is smaller than a predetermined threshold in which case the adaptive learning rate of the parameter is a predetermined bounded value; and
using the adaptive learning rate vector and either the gradient at the current parameter vector of the network or a gradient moving average to calculate an update to the current parameter vector of the network.

2. The method of claim 1, wherein the two or more gradients comprise a first gradient being the gradient at the current parameter vector of the network and a second gradient being the gradient at a second parameter vector obtained by doing an exploratory update to the current parameter vector of the network in the opposite direction of the first gradient, and the DGOD vector is the difference between the second gradient and the first gradient divided by the distance between the second parameter vector and the current parameter vector of the network.

3. The method of claim 1, wherein the two or more gradients comprise a first gradient being a gradient at a parameter vector of the network in a previous iteration of training and a second gradient being the gradient at the current parameter vector of the network, and the DGOD vector is the difference between the second gradient and the first gradient divided by the distance between the current parameter vector of the network and the parameter vector of the network in the previous iteration.

4. The method of claim 1, wherein the DGOD vector is an average DGOD vector which is the difference between a gradient moving average calculated in a current iteration of training and a gradient moving average calculated in a previous iteration of training divided by the distance between the current parameter vector of the network and a parameter vector of the network in the previous iteration.

5. The method of claim 1, wherein the DGOD vector is an average DGOD vector which is a moving average of a plurality of DGOD vectors each of which is calculated from the two or more gradients at the two or more parameter vectors.

6. The method of claim 1, wherein the two or more parameter vectors are three or more parameter vectors, and the DGOD vector is the slope of a linear regression of three or more gradients at the three or more parameter vectors with respect to distances from a first parameter vector of the three or more parameter vectors to the three or more parameter vectors.

7. The method of claim 1, wherein the DGOD vector, the adaptive learning rate vector and the update to the current parameter vector of the network are calculated in a composite calculation.

8. The method of claim 1, wherein the adaptive learning rate of a parameter of the network is a predetermined scalar step size divided by the element of the DGOD vector associated with the parameter, except when the element of the DGOD vector associated with the parameter is less than a predetermined threshold in which case the adaptive learning rate of the parameter is a predetermined maximum learning rate.

9. The method of claim 8, wherein at least one of the scalar step size and the maximum learning rate is adaptively adjusted during training according to a trend of recent training loss.

10. The method of claim 8, wherein at least one of the scalar step size and the maximum learning rate is adaptively adjusted during training and is inversely proportional to variation of the DGOD vectors.

11. An apparatus to train a neural network by iteratively updating parameters of the network to reduce a loss function, the apparatus comprising a processing unit and a storage device storing a computer program that, when executed by the processing unit, causes the processing unit to perform operations comprising:
obtaining two or more gradients of the loss function at two or more parameter vectors wherein the two or more parameter vectors are in a parameter update path;
using the two or more gradients and a distance(s) between the two or more parameter vectors to calculate a derivative of gradient in its opposite direction (DGOD) vector which approximates a directional derivative of a gradient at a current parameter vector of the network in the opposite direction of the gradient at the current parameter vector of the network;
using the DGOD vector to calculate a per-parameter adaptive learning rate vector, wherein an adaptive learning rate of a parameter of the network is inversely proportional to an element of the DGOD vector associated with the parameter, except when the element of the DGOD vector associated with the parameter is smaller than a predetermined threshold in which case the adaptive learning rate of the parameter is a predetermined bounded value; and
using the adaptive learning rate vector and either the gradient at the current parameter vector of the network or a gradient moving average to calculate an update to the current parameter vector of the network.

12. The apparatus of claim 11, wherein the two or more gradients comprise a first gradient being the gradient at the current parameter vector of the network and a second gradient being the gradient at a second parameter vector obtained by doing an exploratory update to the current parameter vector of the network in the opposite direction of the first gradient, and the DGOD vector is the difference between the second gradient and the first gradient divided by the distance between the second parameter vector and the current parameter vector of the network.

13. The apparatus of claim 11, wherein the two or more gradients comprise a first gradient being a gradient at a parameter vector of the network in a previous iteration of training and a second gradient being the gradient at the current parameter vector of the network, and the DGOD vector is the difference between the second gradient and the first gradient divided by the distance between the current parameter vector of the network and the parameter vector of the network in the previous iteration.

14. The apparatus of claim 11, wherein the DGOD vector is an average DGOD vector which is the difference between a gradient moving average calculated in a current iteration of training and a gradient moving average calculated in a previous iteration of training divided by the distance between the current parameter vector of the network and a parameter vector of the network in the previous iteration.

15. The apparatus of claim 11, wherein the DGOD vector is an average DGOD vector which is a moving average of a plurality of DGOD vectors each of which is calculated from the two or more gradients at the two or more parameter vectors.

16. The apparatus of claim 11, wherein the two or more parameter vectors are three or more parameter vectors, and the DGOD vector is the slope of a linear regression of three or more gradients at the three or more parameter vectors with respect to distances from a first parameter vector of the three or more parameter vectors to the three or more parameter vectors.

17. The apparatus of claim 11, wherein the DGOD vector, the adaptive learning rate vector and the update to the current parameter vector of the network are calculated in a composite calculation.

18. The apparatus of claim 11, wherein the adaptive learning rate of a parameter of the network is a predetermined scalar step size divided by the element of the DGOD vector associated with the parameter, except when the element of the DGOD vector associated with the parameter is less than a predetermined threshold in which case the adaptive learning rate of the parameter is a predetermined maximum learning rate.

19. The apparatus of claim 18, wherein at least one of the scalar step size and the maximum learning rate is adaptively adjusted during training according to a trend of recent training loss.

20. The apparatus of claim 18, wherein at least one of the scalar step size and the maximum learning rate is adaptively adjusted during training and is inversely proportional to variation of the DGOD vectors.
